(19) United States
(12) Patent Application Publication
(10) Pub. No.: US 2026/0180170 A1
(43) Pub. Date: Jun. 25, 2026

(54) ANTENNA SWITCHING FOR RADIO FREQUENCY IDENTIFICATION READERS

(71) Applicant: QUALCOMM Incorporated, San Diego, CA (US)

(72) Inventors: Sheng-Yuan TU, San Diego, CA (US); Kiran PATIL, San Diego, CA (US); Venkatraman RAJAGOPALAN, San Diego, CA (US); Scott HOOVER, Del Mar, CA (US); Bhupesh Manoharlal UMATT, San Diego, CA (US); Jayesh BATHIJA, San Diego, CA (US)

(21) Appl. No.: 18/999,058

(22) Filed: Dec. 23, 2024

(51) Int. Cl. H01Q 3/24; G06K 7/10; H01Q 1/22

(52) U.S. Cl. CPC H01Q 3/24; G06K 7/10356; H01Q 1/2208

(57) ABSTRACT

In some aspects, a reader device may communicate with one or more first radio frequency identification (RFID) tags, during at least part of a first time period, using a first antenna of the reader device. The reader device may communicate with one or more second RFID tags, during at least part of a second time period, using a second antenna of the reader device. The reader device may select the second antenna over the first antenna based upon at least one switching metric associated with the first time period. Numerous other aspects are described.

### FIELD OF THE DISCLOSURE

Aspects of the present disclosure generally relate to wireless communication and, for example, to antenna switching for radio frequency identification tags.

### BACKGROUND

Radio frequency identification (RFID) technology generally uses electromagnetic fields to communicate with RFID tags. For example, a reader device may use an electromagnetic interrogation pulse (e.g., a wireless message) to trigger an RFID tag to transmit digital data (e.g., a wireless response) back to the reader device. The RFID tag may be passive (e.g., using the electromagnetic interrogation pulse to power the wireless response) or active (e.g., including a battery or another type of power source).

### SUMMARY

Some aspects described herein relate to a method of wireless communication performed by a reader device. The method may include communicating with one or more first radio frequency identification (RFID) tags, during at least part of a first time period, using a first antenna of the reader device. The method may include communicating with one or more second RFID tags, during at least part of a second time period, using a second antenna of the reader device. The second antenna may be selected over the first antenna based upon at least one switching metric associated with the first time period.

Some aspects described herein relate to a method of wireless communication performed by a reader device. The method may include receiving a first message from an RFID tag using a first antenna of the reader device. The method may include receiving a second message from the RFID tag using a selected antenna of the first antenna or a second antenna of the reader device. The selected antenna may be selected based at least in part on a measurement associated with the first message.

Some aspects described herein relate to an apparatus for wireless communication at a reader device. The apparatus may include one or more memories and one or more processors coupled to the one or more memories. The one or more processors may be configured to cause the reader device to communicate with one or more first RFID tags, during at least part of a first time period, using a first antenna of the reader device. The one or more processors may be configured to cause the reader device to communicate with one or more second RFID tags, during at least part of a second time period, using a second antenna of the reader device. The second antenna may be selected over the first antenna based upon at least one switching metric associated with the first time period.

Some aspects described herein relate to an apparatus for wireless communication at a reader device. The apparatus may include one or more memories and one or more processors coupled to the one or more memories. The one or more processors may be configured to cause the reader device to receive a first message from an RFID tag using a first antenna of the reader device. The one or more processors may be configured to cause the reader device to receive a second message from the RFID tag using a selected antenna of the first antenna or a second antenna of the reader device. The selected antenna may be selected based at least in part on a measurement associated with the first message.

Some aspects described herein relate to a non-transitory computer-readable medium that stores a set of instructions for wireless communication by a reader device. The set of instructions, when executed by one or more processors of the reader device, may cause the reader device to communicate with one or more first RFID tags, during at least part of a first time period, using a first antenna of the reader device. The set of instructions, when executed by one or more processors of the reader device, may cause the reader device to communicate with one or more second RFID tags, during at least part of a second time period, using a second antenna of the reader device. The second antenna may be selected over the first antenna based upon at least one switching metric associated with the first time period.

Some aspects described herein relate to a non-transitory computer-readable medium that stores a set of instructions for wireless communication by a reader device. The set of instructions, when executed by one or more processors of the reader device, may cause the reader device to receive a first message from an RFID tag using a first antenna of the reader device. The set of instructions, when executed by one or more processors of the reader device, may cause the reader device to receive a second message from the RFID tag using a selected antenna of the first antenna or a second antenna of the reader device. The selected antenna may be selected based at least in part on a measurement associated with the first message.

Some aspects described herein relate to an apparatus for wireless communication. The apparatus may include means for communicating with one or more first RFID tags, during at least part of a first time period, using a first antenna of the apparatus. The apparatus may include means for communicating with one or more second RFID tags, during at least part of a second time period, using a second antenna of the apparatus. The second antenna may be selected over the first antenna based upon at least one switching metric associated with the first time period.

Some aspects described herein relate to an apparatus for wireless communication. The apparatus may include means for receiving a first message from an RFID tag using a first antenna of the apparatus. The apparatus may include means for receiving a second message from the RFID tag using a selected antenna of the first antenna or a second antenna of the apparatus. The selected antenna may be selected based at least in part on a measurement associated with the first message.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which systems and/or methods described herein may be implemented.

FIG. 2 is a diagram illustrating example components of one or more devices shown in FIG. 1, in accordance with the present disclosure.

FIG. 3 is a diagram illustrating an example of a radio frequency identification (RFID) protocol, in accordance with the present disclosure.

FIGS. 4A and 4B are diagrams illustrating examples associated with periodic antenna switching for RFID readers, in accordance with the present disclosure.

FIGS. 5A, 5B, and 5C are diagrams illustrating examples associated with antenna switching for RFID readers, in accordance with the present disclosure.

FIGS. 6 and 7 are flowcharts of example processes associated with antenna switching for RFID readers, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Radio frequency identification (RFID) tags are passive (or active) devices that respond to wireless messages from a reader device, such as a user equipment (UE). For example, the reader device may use a query message to trigger an RFID tag to respond with a random number message (e.g., an RN16 message). Additionally, the reader device may use an acknowledgement (ACK) message to trigger the RFID tag to respond with an electronic product code (EPC) or another type of response message.

Performance depends on where RFID tags are located and on an orientation of the reader device. For example, one orientation of the reader device may result in improved performance for a first set of RFID tags while a different orientation of the reader device may result in improved performance for a second set of RFID tags. Therefore, a reader device may be equipped with multiple antennas to try to improve performance for RFID tags in different locations.

Switching between antennas improves quality and reliability of communications at the reader device, which in turn reduces retransmissions and thus conserves power and processing resources at both the reader device and RFID tags. Some implementations described herein enable periodic switching between antennas for RFID operations. As a result, quality and reliability is improved because the reader device may select an optimal antenna for each period. Additionally, or alternatively, some implementations described herein enable switching between antennas for RFID operations on a per-tag basis. As a result, quality and reliability is improved because the reader device may optimize communications with each RFID tag individually.

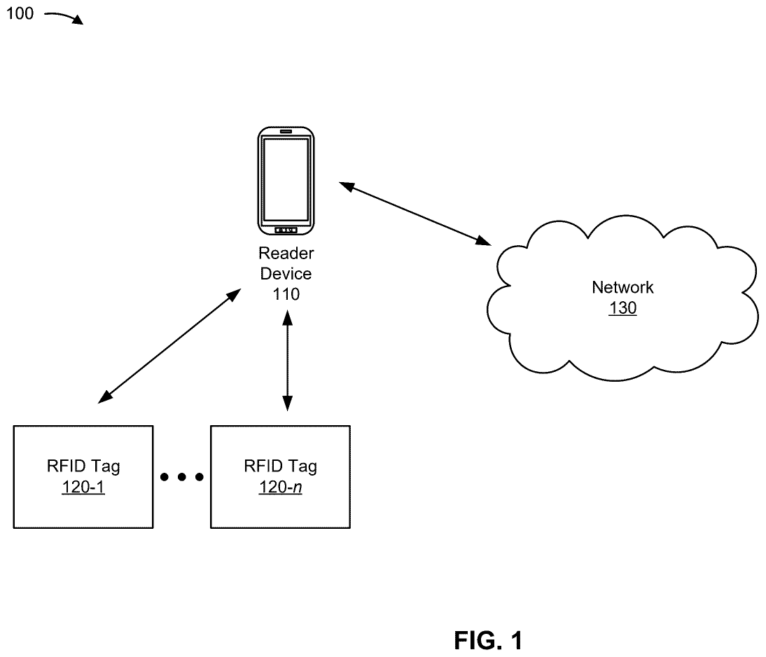

FIG. 1 is a diagram of an example environment 100 in which systems and/or methods described herein may be implemented. As shown in FIG. 1, environment 100 may include a reader device 110, a set of RFID tags 120-1 through 120-n, and a network 130. Devices of environment 100 may interconnect via wired connections, wireless connections, or a combination of wired and wireless connections.

The reader device 110 may include one or more devices capable of receiving, generating, storing, processing, and/or providing information wirelessly, as described elsewhere herein. The reader device 110 may include a communication device and/or a computing device. For example, the reader device 110 may include a wireless communication device, a mobile phone, a UE, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

Each RFID tag 120 may include one or more devices capable of receiving, generating, storing, processing, and/or providing information wirelessly, as described elsewhere herein. Each RFID tag 120 may be passive or active. Each RFID tag 120 may include at least one microchip (e.g., an integrated circuit (IC) configured to store and process information as well as modulate and demodulate radio frequency (RF) signals), an antenna for receiving and transmitting wireless signals, and a substrate. In some aspects, each RFID tag 120 may function according to International Organization for Standardization (ISO) and International Electrotechnical Commission (IEC) standard 18000 (ISO/IEC 18000)).

The reader device 110 may communicate with the set of RFID tags 120-1 through 120-n wirelessly. For example, the reader device 110 may transmit messages (e.g., commands and queries, among other examples) over-the-air (OTA) to the set of RFID tags 120-1 through 120-n, and the set of RFID tags 120-1 through 120-n may transmit responses (e.g., random number messages and EPCs, among other examples) OTA to the reader device 110. Additionally, the reader device 110 may communicate with other devices over the network 130. The network 130 may include a wireless wide area network (e.g., a cellular network or a public land mobile network), a local area network (e.g., a wired local area network or a wireless local area network (WLAN), such as a Wi-Fi network), a personal area network (e.g., a Bluetooth® network), a near-field communication network, a telephone network, a private network, the Internet, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

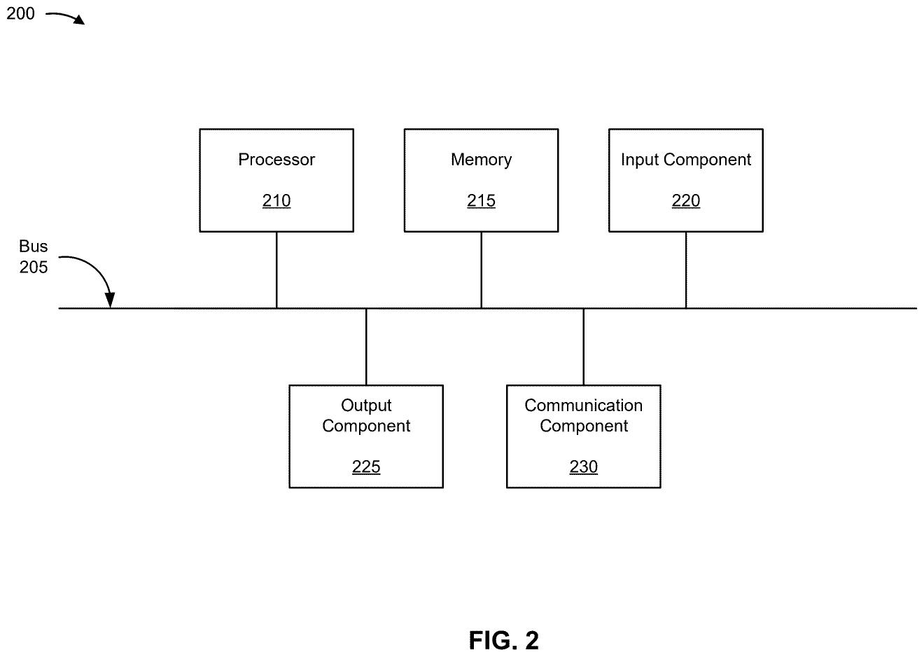

FIG. 2 is a diagram illustrating example components of a device 200, in accordance with the present disclosure. The device 200 may correspond to a reader device 110 and/or an RFID tag 120. In some aspects, a reader device 110 and/or an RFID tag 120 may include one or more devices 200 and/or one or more components of the device 200. As shown in FIG. 2, the device 200 may include a bus 205, a processor 210, a memory 215, an input component 220, an output component 225, and/or a communication component 230.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, and/or an antenna.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, the device 200 may include means for communicating with one or more first RFID tags, during at least part of a first time period, using a first antenna of the reader device; and/or means for communicating with one or more second RFID tags, during at least part of a second time period, using a second antenna of the reader device, wherein the second antenna is selected over the first antenna based upon at least one switching metric associated with the first time period. Additionally, or alternatively, the device 200 may include means for receiving a first message from an RFID tag using a first antenna of the reader device; and/or means for receiving a second message from the RFID tag using a selected antenna of the first antenna or a second antenna of the reader device, wherein the selected antenna is selected based at least in part on a measurement associated with the first message. In some aspects, the means for device 200 to perform processes and/or operations described herein may include one or more components of device 200 described in connection with FIG. 2, such as bus 205, processor 210, memory 215, input component 220, output component 225, and/or communication component 230.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

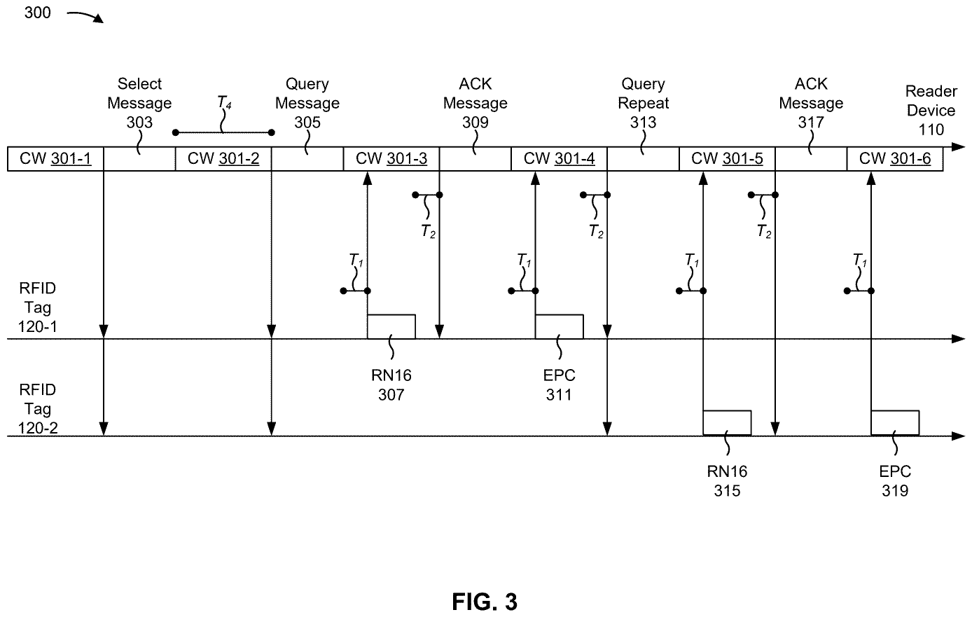

FIG. 3 is a diagram illustrating an example 300 of an RFID protocol, in accordance with the present disclosure. FIG. 3 depicts transmissions scheduled for a reader device 110, a first RFID tag 120-1, and a second RFID tag 120-2 over time. In some aspects, as shown in FIG. 3, the reader device 110 may transmit a carrier wave (CW) 301-1 to allow the RFID tags 120 to perform energy harvesting.

As further shown in FIG. 3, the reader device 110 may transmit a select message 303 to the RFID tags 120 to indicate that the reader device 110 is selecting the RFID tags 120 for operation. The example 300 is for a multi-tag read sequence including both the first RFID tag 120-1 and the second RFID tag 120-2, so the select message 303 may include an identifier associated with a group of RFID tags including the first RFID tag 120-1 and the second RFID tag 120-2. Other examples may include a single-tag read sequence such that the selection message 303 includes an identifier associated with a single RFID tag.

The reader device 110 may further transmit a query message 305 to the RFID tags 120-1 and 120-2. The query message 305 may inform the RFID tags 120-1 and 120-2 of a desired response by the reader device 110 (e.g., an EPC in FIG. 3). As further shown in FIG. 3, the reader device 110 may transmit a CW 301-2 between the select message 303 and the query message 305 to allow the RFID tags 120 to perform energy harvesting. A time between the select message 303 and the query message 305 may be represented by T₄ (e.g., as defined in ISO/IEC 18000).

RFID tags with a slot counter of zero may respond to the query message 305. In FIG. 3, the first RFID tag 120-1 responds. The reader device 110 may transmit a CW 301-3 after the query message 305 in order to enable the first RFID tag 120-1 to transmit an RN16 message 307 (e.g., as defined in ISO/IEC 18000) to the reader device 110 in response to the query message 305. A time between the query message 305 and the RN16 message 307 may be represented by T₁ (e.g., as defined in ISO/IEC 18000). The reader device 110 may transmit an ACK message 309 (e.g., as defined in ISO/IEC 18000) to the first RFID tag 120-1 in response to the RN16 message 307. A time between the RN16 message 307 and the ACK message 309 may be represented by T₂ (e.g., as defined in ISO/IEC 18000).

The reader device 110 may transmit a CW 301-4 after the ACK message 309 in order to enable the first RFID tag 120-1 to transmit an EPC 311 (e.g., as defined in ISO/IEC 18000) to the reader device 110 in response to the ACK message 309. A time between the ACK message 309 and the EPC 311 may be represented by T₁ (e.g., as defined in ISO/IEC 18000).

In order to continue the multi-tag read sequence, the reader device 110 may transmit a query repeat message 313 (e.g., as defined in ISO/IEC 18000) to the RFID tags 120-1 and 120-2. The query repeat message 313 may inform the RFID tags 120-1 and 120-2 of a desired response by the reader device 110 (e.g., an EPC in FIG. 3). A time between the EPC 311 from the first RFID tag 120-1 and the query repeat message 313 may be represented by T₂ (e.g., as defined in ISO/IEC 18000).

RFID tags with a slot counter of zero may respond to the query repeat message 313. In FIG. 3, the second RFID tag 120-2 responds. The reader device 110 may transmit a CW 301-5 after the query repeat message 313 in order to enable the second RFID tag 120-2 to transmit an RN16 message 315 (e.g., as defined in ISO/IEC 18000) to the reader device 110 in response to the query repeat message 313. A time between the query repeat message 313 and the RN16 message 315 may be represented by T₁ (e.g., as defined in ISO/IEC 18000). The reader device 110 may transmit an ACK message 317 (e.g., as defined in ISO/IEC 18000) to the second RFID tag 120-2 in response to the RN16 message 315. A time between the RN16 message 315 and the ACK message 317 may be represented by T₂ (e.g., as defined in ISO/IEC 18000).

The reader device 110 may transmit a CW 301-6 after the ACK message 317 in order to enable the second RFID tag 120-1 to transmit an EPC 319 (e.g., as defined in ISO/IEC 18000) to the reader device 110 in response to the ACK message 317. A time between the ACK message 317 and the EPC 319 may be represented by T₁ (e.g., as defined in ISO/IEC 18000).

Although the example 300 is described using two RFID tags, other examples may include more than two RFID tags. For example, the reader device 110 may continue to use query repeat messages with ACK messages to request responses from additional RFID tags. The single-tag read sequence may have a duration in a range from 1.2 milliseconds (ms) through 50.0 ms, and the multi-tag sequence may be extended by 0.5 ms to 41.0 ms for each additional RFID tag included in the multi-tag sequence.

As indicated above, FIG. 3 is provided as an example. Other examples may differ from what is described with respect to FIG. 3.

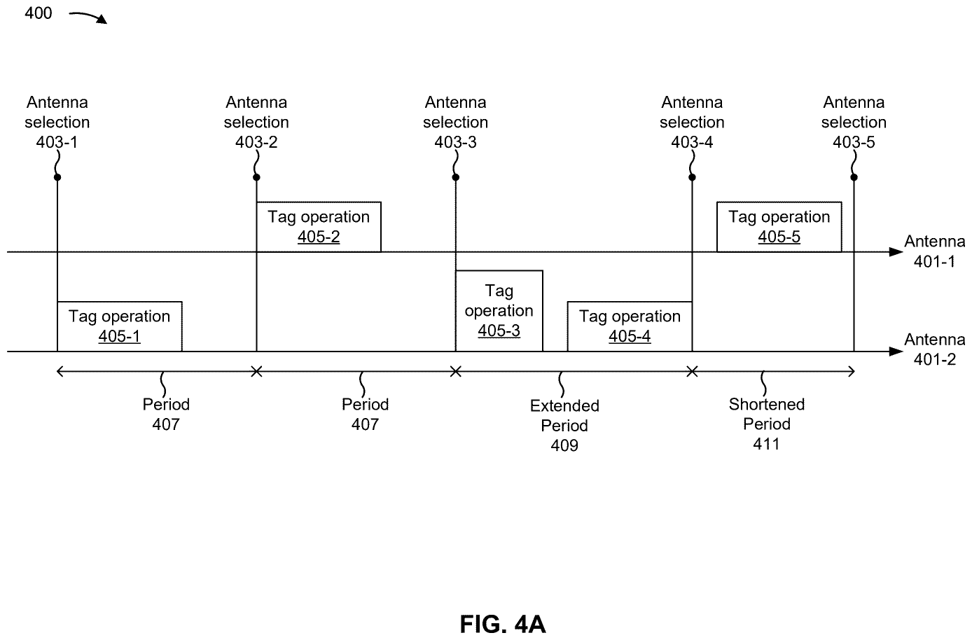

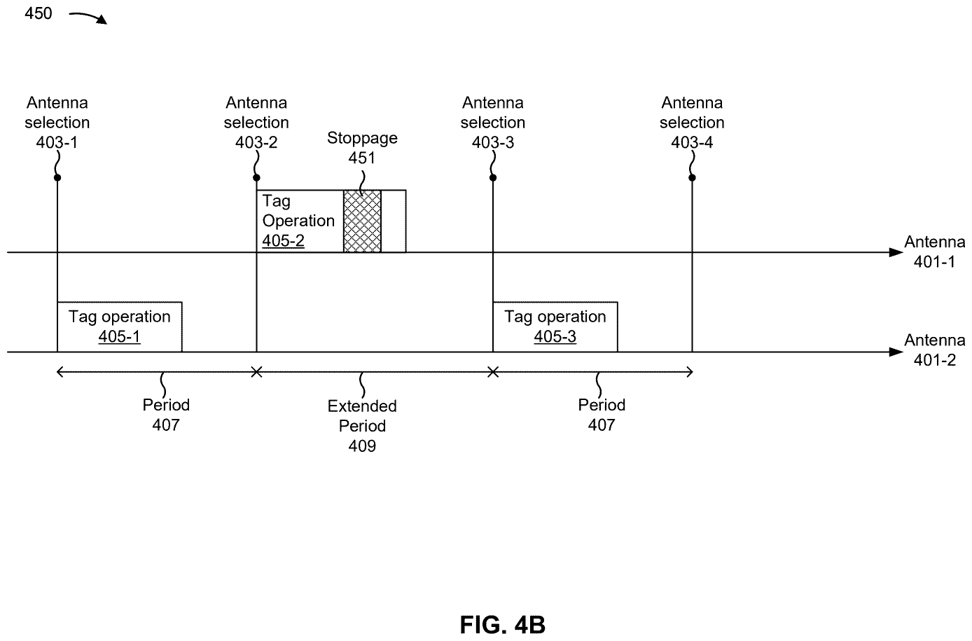

FIG. 4A is a diagram illustrating an example 400 associated with periodic antenna switching for RFID readers, in accordance with the present disclosure. As shown in FIG. 4A, a reader device 110 may switch between an antenna 401-1 and an antenna 401-2 for RFID operations. An initial antenna selection 403-1 may be according to a default setting. For example, the reader device 110 may select the antenna 401-2, and thus the reader device 110 may communicate with a set of RFID tags (e.g., to perform tag operation 405-1) using the antenna 401-2.

After a period 407, the reader device 110 may perform antenna selection 403-2. The period 407 may be a fixed amount of time (e.g., 500 ms or another similar value programmed into the reader device 110) or may be dynamic. For example, the reader device 110 may select the period 407 based on physical properties of the reader device 110 (e.g., a number of available receive chains for RFID operations, a number of available antennas for RFID operations, and/or a clock speed of one or more components of the reader device 110, among other examples) and/or environmental factors (e.g., decreasing the period 407 in response to high temperatures, high humidity, or other environment qualities that decrease channel stability).

The reader device 110 may perform the antenna selection 403-2 according to at least one switching metric. The switching metric(s) may include an expected quantity of RFID tags, a metric associated with a different radio of the reader device 110, a tune-away pattern associated with the different radio, and/or a signal strength measurement, among other examples. The expected quantity of RFID tags may be estimated using a duty cycle (e.g., as determined using transmit power and a specific absorption rate (SAR) constraint) and an expected read rate (e.g., as determined using physical properties of the reader device 110). Accordingly, the reader device 110 may select the antenna 401-1 (in FIG. 4A) because the antenna 401-1 is associated with a larger expected quantity of RFID tags than the antenna 401-2. The metric associated with the different radio may include a correlation between an RFID radio and the different radio (e.g., detecting a blockage using the different radio and correlating the blockage to the RFID radio using the same antenna). Accordingly, the reader device 110 may select the antenna 401-1 (in FIG. 4A) because the antenna 401-2 is associated with a blockage as measured by a wide area network (WAN) radio, a wireless local area network (WLAN) radio, a Bluetooth radio, an ultra-wideband (UWB) radio, or a global network satellite system (GNSS) radio, among other examples, that also uses the antenna 401-2. The tune-away pattern associated with the different radio may include a schedule associated with the different radio (e.g., estimating how long an antenna will tune-away for the different radio in an upcoming period 407). Accordingly, the reader device 110 may select the antenna 401-1 (in FIG. 4A) because the antenna 401-2 is associated with more expected tune-away time than the antenna 401-1. The signal strength measurement may include a received signal strength indicator (RSSI) and/or a signal-to-noise ratio (SNR), among other examples. Accordingly, the reader device 110 may select the antenna 401-1 (in FIG. 4A) because the antenna 401-1 is associated with a better signal strength measurement than the antenna 401-2. The switching metrics described herein may be combined, whether sequentially (e.g., selecting an antenna using one metric and then reconsidering the selection using another metric) or holistically (e.g., scoring each antenna using a combination of metrics and selecting an antenna associated with a best score).

As further shown in FIG. 4A, the reader device 110 may select the antenna 401-1 and communicate with a set of RFID tags (e.g., to perform tag operation 405-2) using the antenna 401-1. The set of RFID tags with which the reader device 110 communicates in the tag operation 405-2 may be the same set of RFID tags as, a different set of RFID tags than, or a partially overlapping set of RFID tags with the set of RFID tags with which the reader device 110 communicates in the tag operation 405-1.

After the period 407, the reader device 110 may perform antenna selection 403-3. The reader device 110 may perform the antenna selection 403-3 similarly as the reader device 110 performed the antenna selection 403-2 but by considering the switching metric(s) over a most recent period 407.

As shown in FIG. 4A, the reader device 110 may select the antenna 401-2 and communicate with a set of RFID tags (e.g., to perform tag operations 405-3 and 405-4) using the antenna 401-2. Because the tag operation 405-4 is ongoing when the period would be set to expire, the reader device 110 may use an extended period 409 in order to avoid interrupting the tag operation 405-4. Accordingly, after the extended period 409, the reader device 110 may perform antenna selection 403-4. The reader device 110 may perform the antenna selection 403-4 similarly as the reader device 110 performed the antenna selection 403-2 but by considering the switching metric(s) over the extended period 409.

As shown in FIG. 4A, the reader device 110 may select the antenna 401-1 and communicate with a set of RFID tags (e.g., to perform tag operation 405-5) using the antenna 401-1. In some aspects, the reader device 110 may use a shortened period 411 to compensate for the extended period 409. Accordingly, after the shortened period 411, the reader device 110 may perform antenna selection 403-5. The reader device 110 may perform the antenna selection 403-5 similarly as the reader device 110 performed the antenna selection 403-2, but by considering the switching metric(s) over the shortened period 411. In other examples, the reader device 110 may instead use another extended period to compensate.

FIG. 4B is a diagram illustrating an example 450 associated with periodic antenna switching for RFID readers, in accordance with the present disclosure. As shown in FIG. 4B, a reader device 110 may switch between an antenna 401-1 and an antenna 401-2 for RFID operations. As in the example 400, the reader device 110 may select the antenna 401-2 at antenna selection 403-1, and thus the reader device 110 may communicate with a set of RFID tags (e.g., to perform tag operation 405-1) using the antenna 401-2. As shown in FIG. 4B, the reader device 110 may perform antenna selection 403-2 and select the antenna 401-1. Accordingly, the reader device 110 may communicate with a set of RFID tags (e.g., to perform tag operation 405-2) using the antenna 401-1.

As further shown in FIG. 4B, the tag operation 405-2 may be interrupted (shown as stoppage 451). The stoppage 451 may be caused by an SAR constraint, a pause to allow for operation of a different radio, and/or a duty cycle requirement according to a local regulation, among other examples. In order to ensure that a time duration to measure the switching metric(s) between both antennas 401-1 and 401-2 are equivalent for fairness, the reader device 110 may use an extended period 409 to account for the stoppage 451. (The reader device 110 may also ignore the stoppage 451 when calculating the switching metric(s) for the antenna 401-2).

Accordingly, after the extended period 409, the reader device 110 may perform antenna selection 403-3. The reader device 110 may select the antenna 401-2 and communicate with a set of RFID tags (e.g., to perform tag operation 405-3) using the antenna 401-2. Unlike in the example 400, the reader device 110 in the example 450 does not compensate for the extended period 409 and instead shifts the antenna selection pattern accordingly. Therefore, after the period 407, the reader device 110 may perform antenna selection 403-4. The reader device 110 may perform the antenna selection 403-4 by considering the switching metric(s) over a most recent period 407.

Although the examples 400 and 450 are described in connection with two antennas, the reader device 110 may include more than two antennas that are configured for RFID use. Accordingly, each antenna selection may consider all possible antennas according to the switching metric(s).

As indicated above, FIGS. 4A and 4B are provided as examples. Other examples may differ from what is described with respect to FIGS. 4A-4B.

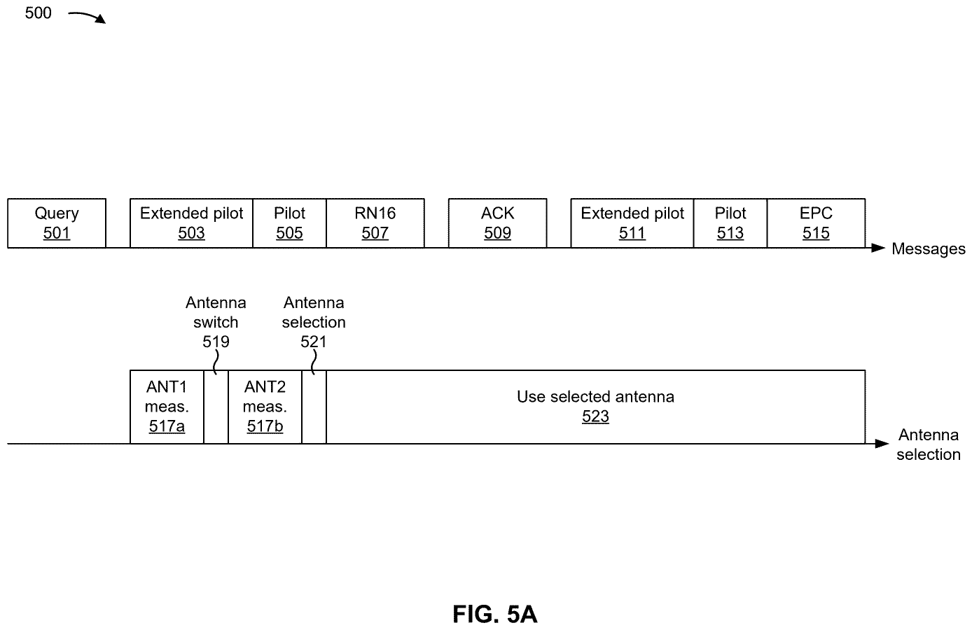

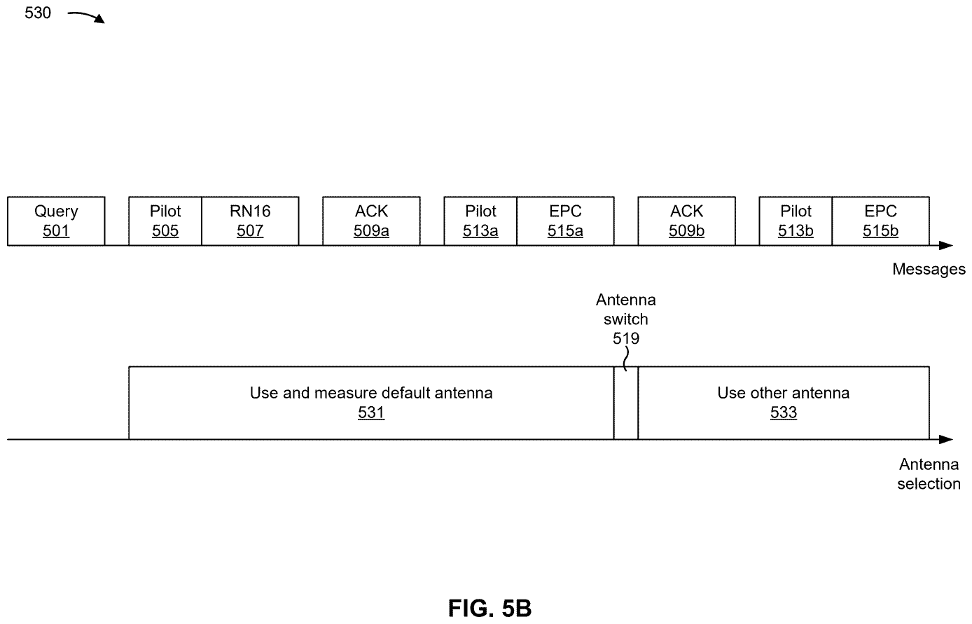

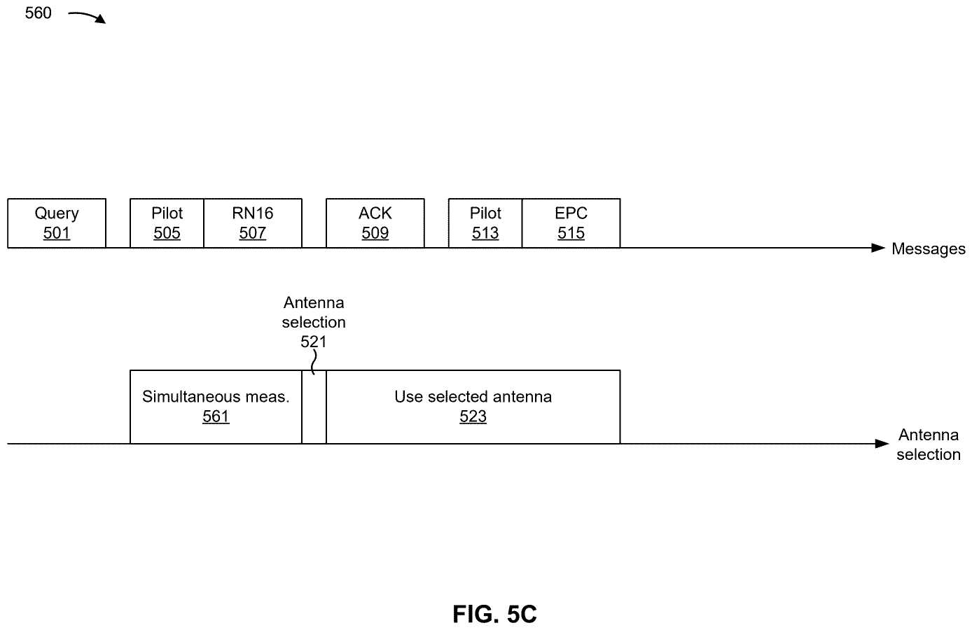

FIG. 5A is a diagram illustrating an example 500 associated with antenna switching for each RFID tag, in accordance with the present disclosure. In FIGS. 5A-5C, a reader device 110 uses a measurement, associated with a first message from an RFID tag 120, to select an antenna for receiving a second message.

FIG. 5A depicts a sequence of transmissions and antenna operations performed by a reader device 110. In FIG. 5A, the reader device 110 transmits a query message 501 to the RFID tag 120 (e.g., as described in connection with FIG. 3). The query message 501 may instruct the RFID tag 120 to extend a pilot associated with a random number message (e.g., RN16 message 507). Accordingly, the RFID tag 120 may transmit an extended pilot 503 and a pilot 505 (e.g., a total of 12 symbols) before the RN16 message 507. The reader device 110 may measure the extended pilot 503 using a first antenna, as shown by reference number 517a, and using a second antenna, as shown by reference number 517b, with an antenna switch 519 between the measurements.

Based on the measurements, the reader device 110 may perform antenna selection 521. For example, the reader device 110 may select an antenna associated with a best signal strength. Accordingly, the reader device 110 may use the selected antenna for remaining messages, as shown by reference number 523. As shown in FIG. 5A, the reader device 110 transmits an ACK message 509 to the RFID tag 120 (e.g., as described in connection with FIG. 3). The RFID tag 120 may respond to the ACK message 509 with an EPC 515. As shown in FIG. 5A, the RFID tag 120 may transmit an extended pilot 511 and a pilot 513 (e.g., a total of 12 symbols) before the EPC 515. Alternatively, the reader device 110 may (e.g., in the query message 501 and/or the ACK message 509) request that the RFID tag 120 only include an extended pilot with the RN16 message 507. Therefore, the RFID tag 120 may omit the extended pilot 511.

Therefore, in the example 500, the first message is the extended pilot 503 and the pilot 505, and the second message is the RN16 message 507 and the EPC 515.

FIG. 5B is a diagram illustrating an example 530 associated with antenna switching for each RFID tag, in accordance with the present disclosure. FIG. 5B depicts a sequence of transmissions and antenna operations performed by a reader device 110.

In FIG. 5B, the reader device 110 transmits a query message 501 to the RFID tag 120 (e.g., as described in connection with FIG. 3). The RFID tag 120 may respond to the query message 501 with an RN16 message 507. As shown in FIG. 5B, the RFID tag 120 may transmit a pilot 505 before the RN16 message 507. The reader device 110 may use a default antenna for the RN16 message 507, as shown by reference number 531.

As shown in FIG. 5B, the reader device 110 transmits an ACK message 509a to the RFID tag 120 (e.g., as described in connection with FIG. 3). The RFID tag 120 may respond to the ACK message 509a with an EPC 515a. As shown in FIG. 5B, the RFID tag 120 may transmit a pilot 513a before the EPC 515 a. The reader device 110 may use the default antenna to receive (and measure) the EPC 515a, as further shown by reference number 531.

Based on the measurement, the reader device 110 may determine to perform an antenna switch 519. For example, the reader device 110 may fail to decode the EPC 515a and thus may determine to use a different antenna in response to the failure to decode the EPC 515a. Accordingly, the reader device 110 may use the other antenna for remaining messages, as shown by reference number 533.

As shown in FIG. 5B, the reader device 110 transmits an additional ACK message 509b to the RFID tag 120 (e.g., as described in connection with FIG. 3). The RFID tag 120 may respond to the additional ACK message 509b with an additional EPC 515b. As shown in FIG. 5B, the RFID tag 120 may transmit an additional pilot 513b before the additional EPC 515b.

Therefore, in the example 530, the first message is the EPC 515a, and the second message is the EPC 515b.

The examples in FIGS. 5A-5B may be combined with the examples in FIGS. 4A-4B. For example, antenna selection may be performed, as described in connection with FIGS. 4A-4B, in order to determine which antenna will be measured first in the example 500. In another example, antenna selection may be performed, as described in connection with FIGS. 4A-4B, in order to determine a default antenna to use in the example 530.

FIG. 5C is a diagram illustrating an example 560 associated with periodic antenna switching for RFID readers, in accordance with the present disclosure. FIG. 5C depicts a sequence of transmissions and antenna operations performed by a reader device 110.

In FIG. 5C, the reader device 110 transmits a query message 501 to the RFID tag 120 (e.g., as described in connection with FIG. 3). The RFID tag 120 may respond to the query message 501 with an RN16 message 507. As shown in FIG. 5C, the RFID tag 120 may transmit a pilot 505 before the RN16 message 507. The reader device 110 may simultaneously receive and measure the pilot 505 and the RN16 message 507 using multiple antennas (and multiple corresponding receive chains), as shown by reference number 561.

Based on the measurements, the reader device 110 may perform antenna selection 521. For example, the reader device 110 may select an antenna associated with a best signal strength. Accordingly, the reader device 110 may use the selected antenna for remaining messages, as shown by reference number 523. As shown in FIG. 5C, the reader device 110 transmits an ACK message 509 to the RFID tag 120 (e.g., as described in connection with FIG. 3). The RFID tag 120 may respond to the ACK message 509 with an EPC 515. As shown in FIG. 5C, the RFID tag 120 may transmit a pilot 513 before the EPC 515.

Therefore, in the example 560, the first message is the RN16 message 507, and the second message is the EPC 515.

As indicated above, FIGS. 5A, 5B, and 5C are provided as examples. Other examples may differ from what is described with respect to FIGS. 5A-5C.

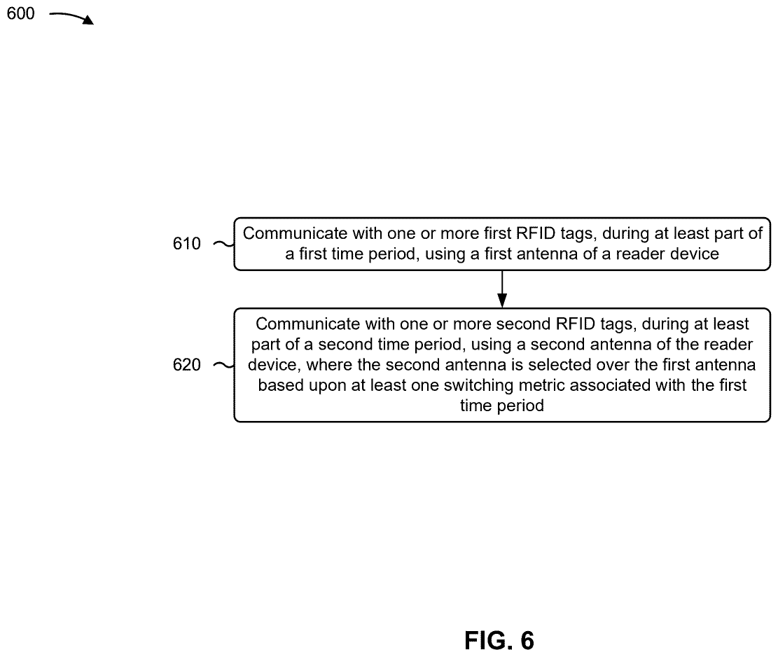

FIG. 6 is a flowchart of an example process 600 associated with antenna switching for RFID readers, in accordance with the present disclosure. In some aspects, one or more process blocks of FIG. 6 are performed by a reader device (e.g., reader device 110). Additionally, or alternatively, one or more process blocks of FIG. 6 may be performed by one or more components of device 200, such as processor 210, memory 215, input component 220, output component 225, and/or communication component 230.

As shown in FIG. 6, process 600 may include communicating with one or more first RFID tags, during at least part of a first time period, using a first antenna of the reader device (block 610). For example, the reader device may communicate with one or more first RFID tags, during at least part of a first time period, using a first antenna of the reader device, as described herein.

As further shown in FIG. 6, process 600 may include communicating with one or more second RFID tags, during at least part of a second time period, using a second antenna of the reader device, where the second antenna is selected over the first antenna based upon at least one switching metric associated with the first time period (block 620). For example, the reader device may communicate with one or more second RFID tags, during at least part of a second time period, using a second antenna of the reader device, where the second antenna is selected over the first antenna based upon at least one switching metric associated with the first time period, as described herein.

Process 600 may include additional aspects, such as any single aspect or any combination of aspects described below and/or in connection with one or more other processes described elsewhere herein.

In a first aspect, process 600 includes communicating with one or more third RFID tags, during at least part of a third time period, using the first antenna of the reader device, where the first antenna is selected over the second antenna based upon at least one switching metric associated with the second time period.

In a second aspect, alone or in combination with the first aspect, process 600 includes communicating with one or more third RFID tags, during at least part of a third time period, using the second antenna of the reader device, where use of the second antenna is continued based upon at least one switching metric associated with the second time period.

In a third aspect, alone or in combination with one or more of the first and second aspects, process 600 includes communicating with one or more third RFID tags, during at least part of a third time period, using a third antenna of the reader device, where the third antenna is selected over the first antenna and the second antenna based upon at least one switching metric associated with the second time period.

In a fourth aspect, alone or in combination with one or more of the first through third aspects, the first time period and the second time period are based at least in part on a periodicity associated with antenna switching.

In a fifth aspect, alone or in combination with one or more of the first through fourth aspects, the first time period is extended in response to an ongoing RFID operation.

In a sixth aspect, alone or in combination with one or more of the first through fifth aspects, the first time period is extended in response to a temporary stop of an RFID operation.

In a seventh aspect, alone or in combination with one or more of the first through sixth aspects, the at least one switching metric includes one or more of: an expected quantity of RFID tags, a metric associated with a different radio of the reader device, a tune-away pattern associated with the different radio, or a signal strength measurement.

In an eighth aspect, alone or in combination with one or more of the first through seventh aspects, the different radio comprises a WAN radio, a WLAN radio, a Bluetooth radio, a UWB radio, or a GNSS radio.

Although FIG. 6 shows example blocks of process 600, in some aspects, process 600 includes additional blocks, fewer blocks, different blocks, or differently arranged blocks than those depicted in FIG. 6. Additionally, or alternatively, two or more of the blocks of process 600 may be performed in parallel.

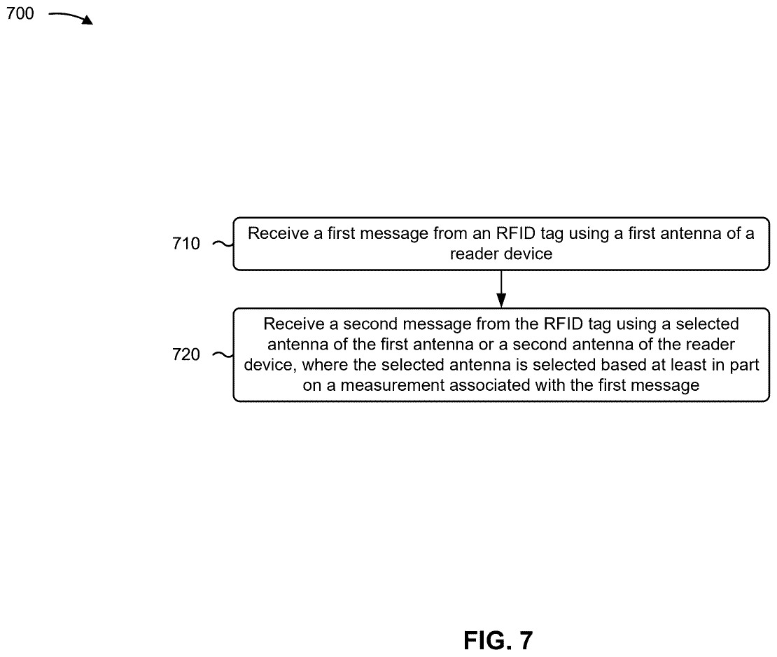

FIG. 7 is a flowchart of an example process 700 associated with antenna switching for RFID readers, in accordance with the present disclosure. In some aspects, one or more process blocks of FIG. 7 are performed by a reader device (e.g., reader device 110). Additionally, or alternatively, one or more process blocks of FIG. 7 may be performed by one or more components of device 200, such as processor 210, memory 215, input component 220, output component 225, and/or communication component 230.

As shown in FIG. 7, process 700 may include receiving a first message from an RFID tag using a first antenna of the reader device (block 710). For example, the reader device may receive a first message from an RFID tag using a first antenna of the reader device, as described herein.

As further shown in FIG. 7, process 700 may include receiving a second message from the RFID tag using a selected antenna of the first antenna or a second antenna of the reader device, where the selected antenna is selected based at least in part on a measurement associated with the first message (block 720). For example, the reader device may receive a second message from the RFID tag using a selected antenna of the first antenna or a second antenna of the reader device, where the selected antenna is selected based at least in part on a measurement associated with the first message, as described herein.

Process 700 may include additional aspects, such as any single aspect or any combination of aspects described below and/or in connection with one or more other processes described elsewhere herein.

In a first aspect, process 700 includes receiving an additional first message from an additional RFID tag using the first antenna of the reader device, and receiving an additional second message from the additional RFID tag using an additional selected antenna of the first antenna or the second antenna of the reader device, where the additional selected antenna is selected based at least in part on a measurement associated with the additional first message.

In a second aspect, alone or in combination with the first aspect, the first message includes a pilot associated with a random number message.

In a third aspect, alone or in combination with one or more of the first and second aspects, a first portion of the pilot is received using the first antenna, and process 700 includes receiving a second portion of the pilot using the second antenna.

In a fourth aspect, alone or in combination with one or more of the first through third aspects, process 700 includes transmitting, to the RFID tag, a message that instructs the RFID tag to extend the pilot associated with a random number message.

In a fifth aspect, alone or in combination with one or more of the first through fourth aspects, the second message includes a body of the random number message and a response message.

In a sixth aspect, alone or in combination with one or more of the first through fifth aspects, an extended pilot is omitted from the response message.

In a seventh aspect, alone or in combination with one or more of the first through sixth aspects, the measurement associated with the first message includes a signal strength associated with the first antenna and a signal strength associated with the second antenna.

In an eighth aspect, alone or in combination with one or more of the first through seventh aspects, the first message includes a random number message.

In a ninth aspect, alone or in combination with one or more of the first through eighth aspects, process 700 includes receiving the random number message using the second antenna simultaneously with the first antenna, where the selected antenna is selected using one or more metrics associated with the random number message.

In a tenth aspect, alone or in combination with one or more of the first through ninth aspects, the second message includes a response message received using the selected antenna.

In an eleventh aspect, alone or in combination with one or more of the first through tenth aspects, the second message includes a response message received using the selected antenna simultaneously with the other antenna of the first antenna or the second antenna.

In a twelfth aspect, alone or in combination with one or more of the first through eleventh aspects, the first message includes a response message.

In a thirteenth aspect, alone or in combination with one or more of the first through twelfth aspects, the measurement associated with the first message includes a status indicator associated with decoding the response message.

In a fourteenth aspect, alone or in combination with one or more of the first through thirteenth aspects, process 700 includes transmitting an acknowledgement message, in response to the status indicator being indicative of failure, to trigger an additional response message from the RFID tag, where the second message includes the additional response message.

Although FIG. 7 shows example blocks of process 700, in some aspects, process 700 includes additional blocks, fewer blocks, different blocks, or differently arranged blocks than those depicted in FIG. 7. Additionally, or alternatively, two or more of the blocks of process 700 may be performed in parallel.

The following provides an overview of some Aspects of the present disclosure:

Aspect 1: A method of wireless communication performed by a reader device, comprising: communicating with one or more first radio frequency identification (RFID) tags, during at least part of a first time period, using a first antenna of the reader device; and communicating with one or more second RFID tags, during at least part of a second time period, using a second antenna of the reader device, wherein the second antenna is selected over the first antenna based upon at least one switching metric associated with the first time period.

Aspect 2: The method of Aspect 1, further comprising: communicating with one or more third RFID tags, during at least part of a third time period, using the first antenna of the reader device, wherein the first antenna is selected over the second antenna based upon at least one switching metric associated with the second time period.

Aspect 3: The method of Aspect 1, further comprising: communicating with one or more third RFID tags, during at least part of a third time period, using the second antenna of the reader device, wherein use of the second antenna is continued based upon at least one switching metric associated with the second time period.

Aspect 4: The method of Aspect 1, further comprising: communicating with one or more third RFID tags, during at least part of a third time period, using a third antenna of the reader device, wherein the third antenna is selected over the first antenna and the second antenna based upon at least one switching metric associated with the second time period.

Aspect 5: The method of any of Aspects 1-4, wherein the first time period and the second time period are based at least in part on a periodicity associated with antenna switching.

Aspect 6: The method of any of Aspects 1-5, wherein the first time period is extended in response to an ongoing RFID operation.

Aspect 7: The method of any of Aspects 1-6, wherein the first time period is extended in response to a temporary stop of an RFID operation.

Aspect 8: The method of any of Aspects 1-7, wherein the at least one switching metric comprises one or more of: an expected quantity of RFID tags; a metric associated with a different radio of the reader device; a tune-away pattern associated with the different radio; or a signal strength measurement.

Aspect 9: The method of Aspect 8, wherein the different radio comprises a wide area network (WAN) radio, a wireless local area network (WLAN) radio, a Bluetooth radio, an ultra-wideband (UWB) radio, or a global network satellite system (GNSS) radio.

Aspect 10: A method of wireless communication performed by a reader device, comprising: receiving a first message from a radio frequency identification (RFID) tag using a first antenna of the reader device; and receiving a second message from the RFID tag using a selected antenna of the first antenna or a second antenna of the reader device, wherein the selected antenna is selected based at least in part on a measurement associated with the first message.

Aspect 11: The method of Aspect 10, further comprising: receiving an additional first message from an additional RFID tag using the first antenna of the reader device; and receiving an additional second message from the additional RFID tag using an additional selected antenna of the first antenna or the second antenna of the reader device, wherein the additional selected antenna is selected based at least in part on a measurement associated with the additional first message.

Aspect 12: The method of any of Aspects 10-11, wherein the first message comprises a pilot associated with a random number message.

Aspect 13: The method of Aspect 12, wherein a first portion of the pilot is received using the first antenna, and the method further comprises: receiving a second portion of the pilot using the second antenna.

Aspect 14: The method of any of Aspects 12-13, further comprising: transmitting, to the RFID tag, a message that instructs the RFID tag to extend the pilot associated with a random number message.

Aspect 15: The method of any of Aspects 12-14, wherein the second message comprises a body of the random number message and a response message.

Aspect 16: The method of Aspect 15, wherein an extended pilot is omitted from the response message.

Aspect 17: The method of any of Aspects 10-16, wherein the measurement associated with the first message includes a signal strength associated with the first antenna and a signal strength associated with the second antenna.

Aspect 18: The method of any of Aspects 10-11, wherein the first message comprises a random number message.

Aspect 19: The method of Aspect 18, further comprising: receiving the random number message using the second antenna simultaneously with the first antenna, wherein the selected antenna is selected using one or more metrics associated with the random number message.

Aspect 20: The method of Aspect 19, wherein the second message comprises a response message received using the selected antenna.

Aspect 21: The method of any of Aspects 19-20, wherein the second message comprises a response message received using the selected antenna simultaneously with the other antenna of the first antenna or the second antenna.

Aspect 22: The method of any of Aspects 10-11, wherein the first message comprises a response message.

Aspect 23: The method of Aspect 22, wherein the measurement associated with the first message includes a status indicator associated with decoding the response message.

Aspect 24: The method of Aspect 23, further comprising: transmitting an acknowledgement message, in response to the status indicator being indicative of failure, to trigger an additional response message from the RFID tag, wherein the second message comprises the additional response message.

Aspect 25: A system configured to perform one or more operations recited in one or more of Aspects 1-24.

Aspect 26: An apparatus comprising means for performing one or more operations recited in one or more of Aspects 1-24.

Aspect 27: A non-transitory computer-readable medium storing a set of instructions, the set of instructions comprising one or more instructions that, when executed by a device, cause the device to perform one or more operations recited in one or more of Aspects 1-24.

Aspect 28: A computer program product comprising instructions or code for executing one or more operations recited in one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a reader device, comprising:
one or more memories; and
one or more processors, coupled to the one or more memories, configured to cause the reader device to:
communicate with one or more first radio frequency identification (RFID) tags, during at least part of a first time period, using a first antenna of the reader device; and
communicate with one or more second RFID tags, during at least part of a second time period, using a second antenna of the reader device,
wherein the second antenna is selected over the first antenna based upon at least one switching metric associated with the first time period.

2. The apparatus of claim 1, wherein the first time period and the second time period are based at least in part on a periodicity associated with antenna switching.

3. The apparatus of claim 1, wherein the first time period is extended in response to an ongoing RFID operation or a temporary stop of an RFID operation.

4. The apparatus of claim 1, wherein the at least one switching metric comprises one or more of:
an expected quantity of RFID tags;
a metric associated with a different radio of the reader device;
a tune-away pattern associated with the different radio; or
a signal strength measurement.

5. The apparatus of claim 4, wherein the different radio comprises a wide area network (WAN) radio, a wireless local area network (WLAN) radio, a Bluetooth radio, an ultra-wideband (UWB) radio, or a global network satellite system (GNSS) radio.

6. An apparatus for wireless communication at a reader device, comprising:
one or more memories; and
one or more processors, coupled to the one or more memories, configured to cause the reader device to:
receive a first message from a radio frequency identification (RFID) tag using a first antenna of the reader device; and
receive a second message from the RFID tag using a selected antenna of the first antenna or a second antenna of the reader device,
wherein the selected antenna is selected based at least in part on a measurement associated with the first message.

7. The apparatus of claim 6, wherein the one or more processors are configured to cause the reader device to:
receive an additional first message from an additional RFID tag using the first antenna of the reader device; and
receive an additional second message from the additional RFID tag using an additional selected antenna of the first antenna or the second antenna of the reader device,
wherein the additional selected antenna is selected based at least in part on a measurement associated with the additional first message.

8. The apparatus of claim 6, wherein the first message comprises a pilot associated with a random number message.

9. The apparatus of claim 8, wherein a first portion of the pilot is received using the first antenna, and wherein the one or more processors are configured to cause the reader device to:
receive a second portion of the pilot using the second antenna.

10. The apparatus of claim 8, wherein the second message comprises a body of the random number message and a response message.

11. The apparatus of claim 10, wherein an extended pilot is omitted from the response message.

12. The apparatus of claim 6, wherein the measurement associated with the first message includes a signal strength associated with the first antenna and a signal strength associated with the second antenna.

13. The apparatus of claim 6, wherein the first message comprises a random number message.

14. The apparatus of claim 13, wherein the one or more processors are configured to cause the reader device to:
receive the random number message using the second antenna simultaneously with the first antenna,
wherein the selected antenna is selected using one or more metrics associated with the random number message.

15. The apparatus of claim 14, wherein the second message comprises a response message received using the selected antenna.

16. The apparatus of claim 14, wherein the second message comprises a response message received using the selected antenna simultaneously with the other antenna of the first antenna or the second antenna.

17. The apparatus of claim 6, wherein the first message comprises a response message.

18. The apparatus of claim 17, wherein the measurement associated with the first message includes a status indicator associated with decoding the response message.

19. The apparatus of claim 18, wherein the one or more processors are configured to cause the reader device to:
transmit an acknowledgement message, in response to the status indicator being indicative of failure, to trigger an additional response message from the RFID tag,
wherein the second message comprises the additional response message.

20. A method of wireless communication performed by a reader device, comprising:
communicating with one or more first radio frequency identification (RFID) tags, during at least part of a first time period, using a first antenna of the reader device; and
communicating with one or more second RFID tags, during at least part of a second time period, using a second antenna of the reader device,
wherein the second antenna is selected over the first antenna based upon at least one switching metric associated with the first time period.
